(19) United States
(12) Patent Application Publication
(10) Pub. No.: US 2008/0226067 A1
(43) Pub. Date: Sep. 18, 2008

(54) Method and Circuit for Encrypting a Data Stream

(75) Inventors: Wiebe De Haan, Eindhoven (NL); Menno Anne Treffers, Eindhoven (NL); Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,025

(22) PCT Filed: Feb. 17, 2005
(86) PCT No.: PCT/IB05/50594

§ 371 Date: Aug. 16, 2006

(30) Foreign Application Priority Data
Feb. 23, 2004 (EP) 04100708.9
Feb. 26, 2004 (EP) 04100754.3

(51) Int. Cl. H04L 9/00

(52) U.S. Cl. 380/200

(57) ABSTRACT

Current legislation requires the possibility of encryption when storing television programmes received by broadcast. However, legacy playback apparatuses will not be able to play back such encrypted data in a regular way, but possibly in a wrong way. This may result in problems like damage of speakers. Therefore, the application intends to hide any of such possibly damaging streams by intentionally providing such streams with a wrong identification during the encryption process. The application provides among others a method and circuit for encryption and a method and circuit for decryption. The application is especially suitable for DVD recorders, but may also be employed for other video and/or audio recorders. The invention may even be used for encrypting non-audiovisual data.

The invention relates to a method of encrypting a data stream comprising at least one stream of audiovisual data.

The invention further relates to a circuit for encrypting a data stream comprising at least one stream of audiovisual data.

The invention also relates to a method of decrypting audiovisual data.

The invention further relates to a circuit for decrypting audiovisual data.

Furthermore, the invention relates to a computer programme product comprising computer readable instruction for programming a processing unit

The invention also relates to a data carrier carrying such computer programme product.

The invention further relates to a programmed computer.

The invention furthermore relates to a data carrier carrying data encrypted using the method according to the invention.

Current legislation requires the possibility of encryption when storing television programmes received by broadcast. Television programmes, in particular digitally broadcasted television programmes, can be provided with copy control information as meta data. Options for the copy control information are among others: do not copy (recording not allowed), copy once (one recording allowed; copying recording not allowed) and copy free (free distribution of the content allowed within the personal environment of the consumer). And even when the copy free information is broadcasted with the television programmes, it may be required to encrypt any stored part of the television programme. This requirement is set in a further broadcast flag.

This requires implementation of encryption hardware and/or software in video recorders like DVD recorders. The problem is, however, that the installed base of e.g. DVD players does not support encryption. This can be solved by buying new equipment, but this is expensive. And on legacy equipment, legacy audiovisual material can still be reproduced. Furthermore, not all programmes recorded by video recorders with encryption functionality encrypt programmes when they record them. Besides that, the new video recorders with encryption functionality will be able to play back encrypted content. Therefore, it is not always directly necessary to discard the legacy DVD players.

However, as content on a DVD may be mixed, i.e. encrypted content is stored next to non-encrypted content, a user may try to playback encrypted content on a non-compliant DVD-player. With respect to reproduction of video data, this will result in not very interesting blocks on the screen. With respect to reproduction of audio data, this will result in noise, ticks et cetera, which can be quite loud. The loud noise may damage equipment (speakers) and/or the ears of a user, especially when he or she wears headphones.

It is an object of the invention to prevent playback such possibly damaging streams on legacy playback devices.

To achieve this object, the invention provides in a first aspect a method of encrypting a data stream comprising at least one stream of audiovisual data, comprising steps of: segmenting the stream of audiovisual data in data segments; providing the data segments with ID data in an ID segment, the ID data being different from ID data being pre-determined to identify the type of data in the stream of audiovisual data; and partly encrypting the data segments, leaving the ID segment unencrypted.

When during encrypting audiovisual data for storage on a DVD for example the ID data of audio data is modified to ID data not compliant with the DVD standard, a legacy DVD-player will not recognise the audio as such and will not reproduce any audio. In this way, a speaker of reproduction equipment will not be damaged.

European patent application with application number 03104402.7 proposes a navigation structure to shield encrypted content from legacy devices through special navigation commands. However, this method relies on the fact that recorders do a perfect job and that players will never find their way around the navigation shield. In practise, this cannot always be guaranteed. For example, some players allow direct playback of a file comprising audiovisual data.

In a further embodiment of the method according to the invention, the data stream comprises multiple streams of different types of audiovisual data and data segments of at least one stream of audiovisual data are encrypted.

Usually, audiovisual data is provided in various ways, at least with audio and video data. Besides that, also data related to interactive applications may be provided. An example of this is Digital Video Broadcasting with Mulitmedia Home Platform (interactive) functionality. The different types of data are provided in separated streams, multiplexed or to be multiplexed in on single data stream.

In yet a further embodiment of the method according to the invention, data segments of at least one stream of audiovisual data is provided with ID segments comprising ID data being different from ID data being pre-determined to identify the type of data in the stream of audiovisual data.

When the data stream comprises multiple stream of audiovisual data (or other types of data) and only prevention of reproduction of one of those streams comprises by the data stream is desired, only the ID data of data packets for that stream has to be changed. In this way, only data of that particular stream will not be reproduced by a legacy device, whereas the data of other stream will be reproduced.

In another embodiment of the method according to the invention, the data segments are provided with further ID data in the ID segment, the further ID data being pre-determined to identify the type of data in the stream of audiovisual data and the further ID data being in a further step replaced by the ID data being different from ID data being pre-determined to identify the type of data in the stream of audiovisual data.

An advantage of this embodiment is that standard, already existing circuitry can be used that provides the data segments with the pre-determined ID data for identifying that type of data. Of course, this is at the cost of a separate additional circuit for modifying the pre-determined ID data.

The invention provides in a second aspect a circuit for encrypting a data stream comprising at least one stream of audiovisual data, comprising: a segmenting unit for segmenting the stream of audiovisual data in data segments; a unit for providing the data segment with ID data in an ID segment, the ID data being different from ID data being pre-determined to identify the type of data in the stream of audiovisual data; and an encryption unit for partly encrypting the data segments, leaving the ID segment unencrypted.

The invention provides in a third aspect an apparatus for storing data, comprising: a receiver for receiving data; the circuit according to claim 10; and a storage device for storing the encrypted data on a storage medium.

The invention provides in a fourth as aspect a method of decrypting audiovisual data encrypted using to the method as claimed in claim 1, comprising the steps of: decrypting the partly encrypted data segments; recognising that the data carried by the ID segment is different from ID data being pre-determined to identify the type of data in the stream of audiovisual data and recognising the actual type of data comprised by the data segments; and forming a stream of audiovisual data from the data segments.

The invention provides in a fifth aspect a circuit for decrypting audiovisual data encrypted by the circuit as claimed in claim 10, comprising: a decryption unit for decrypting the partly encrypted data segments; an identification unit for recognising that the data carried by the ID segment is different from ID data being pre-determined to identify the type of data in the stream of audiovisual data and recognising the actual type of data comprised by the data segments; and a streaming unit for forming a stream of audiovisual data from the data segments.

The invention provides in a sixth aspect an apparatus for rendering and retrieving audiovisual data, comprising: a storage device for retrieving data from a storage medium; the circuit according to claim 15; and a circuit for rendering the decrypted stream of audiovisual data.

The invention provides in a seventh aspect a computer programme product comprising computer readable instruction for programming a processing unit for executing the method according to claim 1.

The invention provides in an eight aspect a data carrier carrying the computer programme product as claimed in claim 1.

The invention provides in a ninth aspect a programmed computer enabled to execute the method according to claim 1.

The invention provides in a tenth aspect a computer programme product comprising computer readable instruction for programming a processing unit for executing the method according to claim 13.

The invention provides in an eleventh aspect a data carrier carrying the computer programme product as claimed in claim 13.

The invention provides in a twelfth aspect a programmed computer enabled to execute the method according to claim 13.

The invention provides in a thirteenth aspect a data carrier carrying data encrypted using the method according to claim 1.

The invention will be further elucidated by means of Figs., wherein:

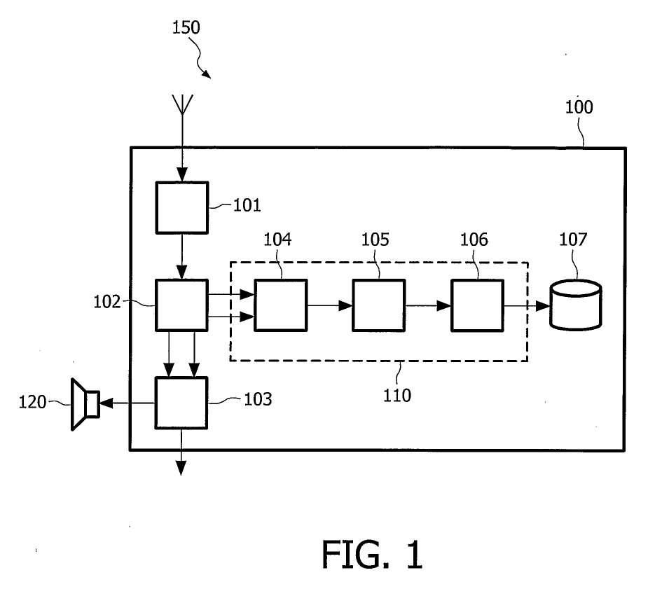

FIG. 1 shows a video recorder 100 as an embodiment of the apparatus for storing data according to the invention;

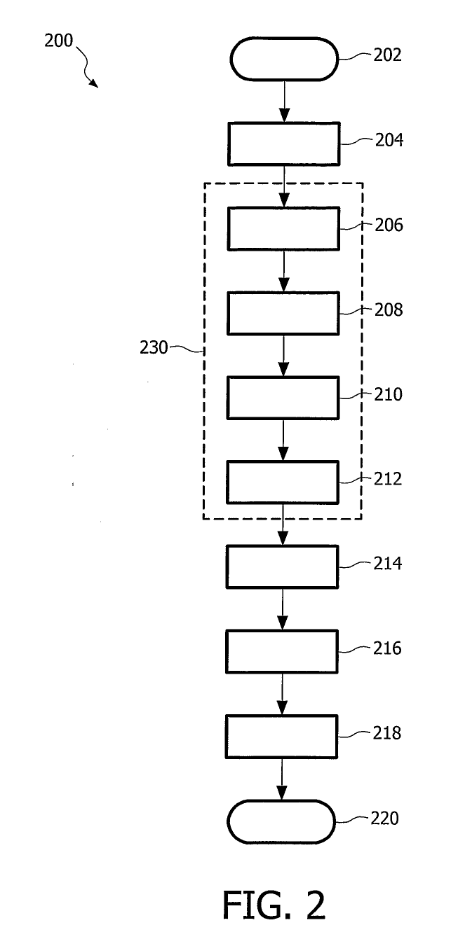

FIG. 2 shows a flowchart depicting an embodiment of the method for encrypting a data stream according to the invention;

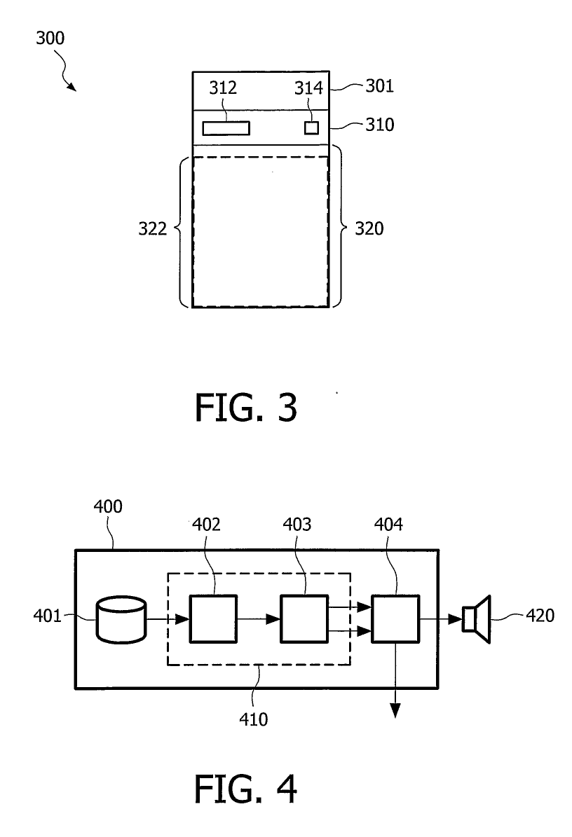

FIG. 3 shows a data pack produced by the method depicted by the flowchart shown by FIG. 2; and

FIG. 4 shows a DVD player as an embodiment of the apparatus for retrieving and rendering data according to the invention.

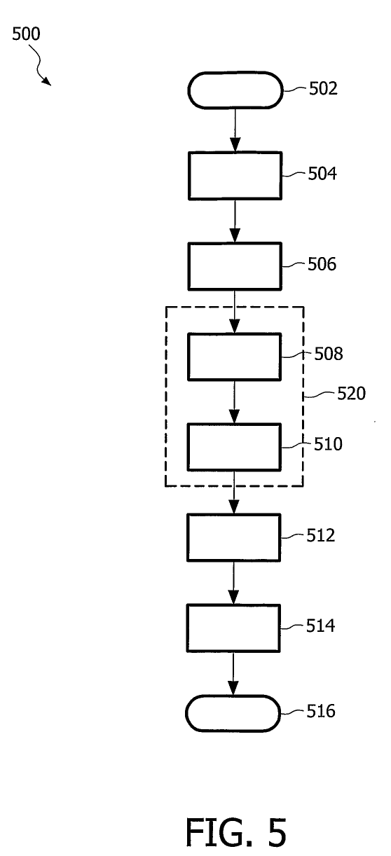

FIG. 5 shows a flowchart depicting an embodiment of the method for retrieving and rendering data according to the invention;

FIG. 1 shows a video recorder 100 as an embodiment of the apparatus according to the invention. The video recorder 100 comprises a receiver 101, a de-multiplexer 102, a video processor 103 as a rendering unit, a coding circuit 110 as an embodiment of the circuit according to the invention, the coding circuit 110 comprising a multiplexer 104, an encryption unit 105 and a packet identifier unit 106. The video recorder further comprises a DVD recorder drive 107 as a storage device.

The operation of the video recorder 100 will be described by means of FIG. 1 and a flowchart 200 as depicted in FIG. 2, showing a recording process as an embodiment of the process according to the invention. The processes of the flowchart 200 are labelled as indicated in Table 1.

TABLE 1

| Reference | |
|---|---|
| numeral: | Label of process step |
| 202 | Start recording procedure, user input |
| 204 | Receiving data stream |
| 230 | Multiplexing packs |
| 206 | Segmenting streams |
| 208 | Adding ID data to segments |
| 210 | Putting segments in packs |
| 212 | Sequencing packs |
| 214 | Encrypting packs |
| 216 | Alter ID data of basic audio stream segments |
| 218 | Store stream |
| 220 | End procedure |

The recording process starts by means of a user input in a process step 200. In a further embodiment, the recording process starts by means of an automatically generated input of a programming unit conceived to programme recordings by the video recorder 100.

Next, a data stream comprising data to record is received by the receiver 101 in a process step 202. The data stream can be received by receiving a signal 150 comprising the data by a wireless connection, a broadcast wired connection like cable, or a (virtual) point to point connection like broadband internet; various embodiments of the receiving process step 202 and the receiver 101 are possible. Having received the signal 150, the data stream is extracted from the signal and provided to the de-multiplexer 102. The extracted data stream is in this embodiment a transport stream comprising audio and video data streams for a television programme. In the further course of this description as well as the claims accompanying this patent application, both types of data will be referred to as audiovisual data, even when there is only audio or video data.

The de-multiplexer 102 separates the various audiovisual data streams comprised by the extracted programme stream to usually an elementary audiostream and an elementary videostream. A preferred format for these elementary streams is the MPEG-2 format. The programme stream may also comprise a stream with data for interactive television applications and a stream with data for enhancing the elementary audiostream and/or the elementary videostream. In FIG. 2, the de-multiplexing process step is comprised by the receiving process step 202.

The elementary audiostream and the elementary videostream are provided to the video processor 103 for rendering the audiovisual data comprised by the elementary streams. For this description, rendering means that the MPEG-2 data (in case of the present embodiment) is decompressed and transformed for reproduction by a speaker 120 and a TV-set (not shown).

Besides rendering, the video recorder 100 is also capable of recording the received data. To this, the data received by the receiver 101 and de-multiplexed by the de-multiplexer 102 (both in the process step 204) is segmented in data segments in a process step 206. The data segments are also known as (data) packets.

Subsequently, ID data is added to the segments in a process step 208 to identify the type of data comprised by the segments. The ID data identifies the type of data comprised by the segment and is pre-defined to facilitate playback of the stored data by a playback apparatus like a DVD (Digital Versatile Disc) player. For the DVD standard, the values of stream IDs as in Table 2 have been agreed. The ID data is comprised by a data segment (or data packet) header.

Table 2 also comprises information on sub stream IDs. Sub streams are comprised by a private stream comprised by the total data stream on a DVD. The sub streams provide further information, complementary to the basic audio and video data. Examples are AC-3, audio, DTS (Digital Theatre System), SDDS (Sony Dynamic Digital Sound), LPCM (Linear Pulse Code Modulation) and other.

TABLE 2

| | stream_id | sub_stream_id |
|---|---|---|
| MPEG Audio (base) | 1100 0xxx | N/A |
| MPEG Audio (ext) | 1101 0xxx | N/A |
| AC-3 | 1011 1101 | 1000 0xxx |
| DTS | 1011 1101 | 1000 1xxx |
| SDDS | 1011 1101 | 1001 0xxx |
| LPCM | 1011 1101 | 1010 0xxx |

In a subsequent process step 210, the segments are arranged in data packs. Data packs comprise data segments of one type of stream. This implies that a data pack may comprise data of multiple sub streams, although this is not the case in the preferred embodiment, and this is not allowed by the DVD standard. Optionally, data packs comprise a padding pack when not enough data of one stream is available to fill the 2 kB of the agreed data pack size. The packs are provided with a header for identification and to provide timing information for synchronising audio and video data.

In a subsequent process step 212, the data packs with the audiovisual data are put in sequence in one data stream. As prescribed by the DVD standard. These writing units are expensive commodities, so limiting the number used to one is important.

Process steps numbered 206 through 212 form a sub process 230 which is carried out by the multiplexer 104. As a person skilled in the art will appreciate, these process steps may also be carried out by separate components.

After the packs have been put in one stream, they are encrypted by the encryption unit 105 in a process step 214. This encryption is done partly, so a playback apparatus is still able to read at least some data segment and data pack identification information of each pack. Preferably, the first 128 bytes of a data pack are not encrypted.

After the process step 214, data packs are obtained as depicted in FIG. 3. FIG. 3 shows a data pack 300, comprising a pack header 301, a data segment header 302 and a payload 320. The pack header 301 comprises data for identifying the data pack, the data segment header 302 comprises an ID segment 312 identifying the type of data comprised by the payload 320 (as set out in Table 2). The scramble information is comprised by two bits in the scramble identification bits 314.

In a subsequent process step 216, the ID data segment of data segments comprising audio data is modified by the packet identifier unit 106. In this way, the audio packets are not recognised as such by a playback apparatus such as a legacy DVD player. This is done to prevent possible playback on a device that is not able to decrypt the packets. When a legacy DVD player, i.e. a DVD player not comprising an embodiment of the circuit of decryption according to the invention, would recognise an encrypted packet as comprising audio data, the legacy DVD player would try to playback the encrypted data. Although not intended, it is still possible that audio is played back. This is because not all audio data is encrypted; the first part of data packs stored on a DVD are in the clear and may comprise data which the DVD-player uses for synchronisation. Usually, this will result in a lot of noise that could damage audio equipment such a speakers and, when played back over headphones, harm the ears of a user wearing the headphones.

When no audio data is recognised because the proper stream_id is not found, no audio will be played back and only decrypted video will be played back. This is not very interesting to watch, but does not harm the legacy DVD-player.

Inventors propose modification of the stream_id and sub_stream_id values as shown in Table 3. As a person skilled in the art will appreciate, modifications of this scheme are possible; Table 3 merely provides an embodiment.

TABLE 3

| | original | | modified | |
|---|---|---|---|---|
| | stream_id | sub_stream_id | stream_id | sub_stream_id |
| MPEG Audio | 1100 0xxx | N/A | 1100 1xxx | N/A |
| (base) | | | | |
| MPEG Audio | 1101 0xxx | N/A | 1101 1xxx | N/A |
| (ext) | | | | |
| AC-3 | 1011 1101 | 1000 0xxx | 1011 1101 | 1100 0xxx |
| DTS | 1011 1101 | 1000 1xxx | 1011 1101 | 1100 1xxx |
| SDDS | 1011 1101 | 1001 0xxx | 1011 1101 | 1101 0xxx |
| LPCM | 1011 1101 | 1010 0xxx | 1011 1101 | 11110xxx |

For the private stream, also the stream_id can be modified instead of the sub_stream_id. In Table 4, only stream_ids are modified, not the sub_stream_ids. Video, audio and sub_picture streams are now all hidden. An additional advantage of not including the sub_stream_ids is that it is not necessary to parse the stream to find the location of the stream ID, as it is always stored in the 18^{th} byte of the pack.

TABLE 4

| | | Modified | |
|---|---|---|---|
| | Stream_id | stream_id | Comment |
| MPEG-audio base | 1100 0xxx | 1100 1xxx | Data mapped to valid MPEG |
| stream | | | audio streamnumber, not used |
| | | | by DVD (DVD |
| | | | streamnumer + 8) |
| MEG-Audio ext | 1101 0xxx | 1101 1xxx | Data mapped to valid MPEG |
| stream | | | Audio streamnumber, not |
| | | | used by DVD (DVD |
| | | | stream number + 8) |
| Video stream | 1110 0000 | 1110 1000 | Data mapped to unused video |
| | | | stream number 8 |
| Private stream 1 | 1011 1101 | 1110 1111 | Data mapped to unused video |
| (used for AC-3, | | | stream number 15 |
| DTS, sub-picture, | | | |
| LPCM etc.) | | | |

Having modified the ID data of the audio stream of the data to store, the encrypted data packs are stored by the DVD recorder drive 107 in a process step 218.

After all data has been stored, the process ends in a terminator 220 of the flowchart 200.

It will be apparent to a person skilled in the art that altered ID data can also be added directly by the multiplexer 104, instead of by a separate unit. Also, the order of the encryption and altering the ID data can be swapped in a further embodiment.

FIG. 4 shows a DVD player 400 as an embodiment of the apparatus for rendering and retrieving audiovisual data according to the invention. The DVD player 400 comprises a DVD drive 401 as a storage device, a decryption unit 402, a de-multiplexer 403 and a video processor 404. The decryption unit 402 and the de-multiplexer 403 form a circuit 410 an embodiment of the circuit for decrypting data according to the invention. The video processor 404 can be embodied as a MPEG decoder. The method of operation of the DVD player 400 will be elucidated by means of a flowchart 500 in FIG. 5 depicting a retrieval and rendering process as an embodiment of the method of retrieving and rendering data according to the invention.

TABLE 5

| Reference numeral: | Label of process step |
|---|---|
| 502 | Initiate playback |
| 504 | Retrieve data to play back |
| 506 | Decrypt packs |
| 508 | Identify proper streams |
| 510 | Build elementary streams |
| 520 | De-multiplexing packs |
| 512 | Render elementary streams |
| 514 | Reproduce rendered data |
| 516 | Selected data played back |

When playback of encrypted data stored on a DVD is requested in a process step 502, data is retrieved from the DVD by the DVD drive 401 in a subsequent process step 504. Next, the packs are decrypted by the decryption unit 402 in a process step 506. The de-multiplexer 403 is adapted to recognise modified ID data. This means that it is able to recognise data for the MPEG audio stream, even though the stream_id is different from what has been defined by the DVD standard. Identification of the proper streams is done n a process step 508.

In a subsequent process step 510, the de-multiplexer forms elementary streams from the packets, delivering it to a video processor 404 for rendering to provide a signal that can be reproduced on a speaker 420 or a TV-set (not shown). The process step 508 and the process step 510 form a sub process 520 that in this embodiment is carried out by the de-multiplexer 403.

Next, the elementary streams are rendered for proper reproduction by a speaker and/or screen in a process step 512 by the video processor 404. Subsequently, the rendered data is reproduced by a speaker 420 and a screen (not shown) in a process step 514. The retrieval and rendering process depicted by the flowchart 500 ends in a terminator 516 when all data to be played back has been played back.

In a further embodiment of the invention, the stream_id of the original audio stream is modified and an empty audio stream is provided with the prescribed audio stream_id. This may be applied to audio as well as video or both data types. Providing empty data streams does not mean that all data streams are empty indeed. For example, the minimum bitrate of an AC-3 stream is 64 kbps. A playback device as an embodiment of the apparatus for rendering and retrieving audiovisual data according to the invention will discard the empty stream or streams. The playback device will also recognise the modified stream_ids and decrypt and playback the decrypted data.

Various other embodiments of the invention are possible without departing from the scope of the invention. For example, a function being described as being carried out by one element may also be carried out by multiple elements and vice versa.

Also, the data may be stored on a whole range of data carriers ranging from optical carriers in accordance with various standards as Compact Disc®, Super Audio Compact Disc®, BluRay® to solid state carriers like flash EEPROM circuits and even comprising digital video tape.

As a person skilled in the art, the invention may also be embodied as a computer programme product comprising computer readable instruction for programming a processing unit for executing the methods according to the invention, a data carrier carrying such computer programme product and a programmed computer enabled to execute one or more of the methods according to the invention.

In summary, the invention relates to the following:

Current legislation requires the possibility of encryption when storing television programmes received by broadcast. However, legacy playback apparatuses will not be able to play back such encrypted data in a regular way, but possibly in a wrong way. This may result in problems like damage of speakers. Therefore, the invention intends to hide any of such possibly damaging streams by intentionally providing such streams with a wrong identification during the encryption process. The invention provides among others a method and circuit for encryption and a method and circuit for decryption. The invention is especially suitable for DVD recorders, but may also be employed for other video and/or audio recorders. The invention may even be used for encrypting non-audiovisual data.

1. Method (200) of encrypting a data stream comprising at least one stream of audiovisual data, comprising steps of:
(a) segmenting (206) the stream of audiovisual data in data segments (320);
(b) providing (216) the data segments with ID data in an ID segment (312), the ID data being different from ID data being pre-determined to identify the type of data in the stream of audiovisual data; and
(c) partly encrypting (214) the data segments, leaving the ID segment unencrypted.

2. Method according to claim 1, wherein the method further comprises the step of creating (210) data packs (300), each data pack comprising at least one data segment and wherein in the step of partly encrypting the data segments, the ID segment of at least on data segment is unencrypted.

3. Method according to claim 1, wherein the data stream comprises multiple streams of different types of audiovisual data and data segments of at least one stream of audiovisual data are encrypted.

4. Method according to claim 3, wherein data segments of at least one stream of audiovisual data is provided with ID segments comprising ID data being different from ID data being pre-determined to identify the type of data in the stream of audiovisual data.

5. Method according to claim 3, wherein the multiple streams of audiovisual data are provided simultaneously and the method further comprising the step of multiplexing (212, 230) the segments comprising data of the multiple streams of audiovisual data to a further data stream.

6. Method according to claim 1, wherein the data segments are provided (208) with further ID data in the ID segment, the further ID data being pre-determined to identify the type of data in the stream of audiovisual data and the further ID data being in a further step (216) replaced by the ID data being different from ID data being pre-determined to identify the type of data in the stream of audiovisual data.

7. Method according to claim 2, wherein the data packs are MPEG-2 data stream packs.

8. Method according to claim 1, wherein the ID data being pre-determined to identify the type of data in the stream of audiovisual data is pre-determined by the DVD standard.

9. Method according to claim 1, further comprising the step of providing an empty stream of audiovisual data of the same type as the stream of audiovisual data for which non pre-determined ID data has been provided, the empty stream of audiovisual data being provided with ID data pre-determined for identifying that type of data.

10. Method (300) of storing a data stream comprising at least one stream of audiovisual data, comprising the step of receiving the data stream, the method as claimed in claim 1 and the step of storing the segmented and encrypted data on a storage medium.

11. Circuit (110) for encrypting a data stream comprising at least one stream of audiovisual data, comprising:
(a) a segmenting unit (104) for segmenting the stream of audiovisual data in data segments;
(b) a unit (106) for providing the data segment with ID data in an ID segment, the ID data being different from ID data being pre-determined to identify the type of data in the stream of audiovisual data; and
(c) an encryption unit (105) for partly encrypting the data segments, leaving the ID segment unencrypted.

12. Circuit according to claim 11, further comprising a packing unit (104) for creating data packs (300), each data pack comprising at least one data segment; and wherein in the step of partly encrypting the data segments, the ID segment of at least on data segment is unencrypted.

13. Apparatus for storing data, comprising:
(a) a receiver (101) for receiving data;
(b) the circuit according to claim 11; and
(c) a storage device (107) for storing the encrypted data on a storage medium (107).

14. Method (500) of decrypting audiovisual data encrypted using to the method as claimed in claim 1, comprising the steps of:
(a) decrypting (506) the partly encrypted data segments (320, 300);
(b) recognising (508) that the data carried by the ID segment is different from ID data being pre-determined to identify the type of data in the stream of audiovisual data and recognising the actual type of data comprised by the data segments; and
(c) forming (510) a stream of audiovisual data from the data segments.

15. Method (500) of retrieving and rendering stored data, comprising:
(a) the step of retrieving (504) data stored on a storage medium;
(b) the step of decrypting (506) the partly encrypted data segments (320, 300)
(c) the step of recognising (508) that the data carried by the ID segment is different from ID data being pre-determined to identify the type of data in the stream of audiovisual data and recognizing the actual type of data comprised by the data segments
(d) the step of forming (510) a stream of audiovisual data from the data segments; and
(e) the step of rendering the decrypted stream of audiovisual data.

16. Circuit (410) for decrypting audiovisual data encrypted by the circuit as claimed in claim 11, comprising:
(a) A decryption unit (402) for decrypting the partly encrypted data segments;
(b) An identification unit (403) for recognising that the data carried by the ID segment is different from ID data being pre-determined to identify the type of data in the stream of audiovisual data and recognising the actual type of data comprised by the data segments; and
(c) A streaming unit (403) for forming a stream of audiovisual data from the data segments.

17. Apparatus for rendering and retrieving audiovisual data, comprising:
(a) a storage device (401) for retrieving data from a storage medium;
(b) the circuit according to claim 16; and
(c) a circuit (404) for rendering the decrypted stream of audiovisual data.

18. Computer programme product comprising computer readable instruction for programming a processing unit for executing the method according to claim 1.

19. Data carrier carrying the computer programme product as claimed in claim 1.

20. Programmed computer enabled to execute the method according to claim 1.

21. Computer programme product comprising computer readable instruction for programming a processing unit for executing the method according to claim 14.

22. Data carrier carrying the computer programme product as claimed in claim 14.

23. Programmed computer enabled to execute the method according to claim 14.

24. Data carrier (107, 401) carrying data encrypted using the method according to claim 1.

25. Data carrier according to claim 24, wherein the data carrier is a DVD recordable disc.

26. Data carrier according to claim 24, wherein the data carrier is a DVD rewritable disc.
